(19) United States
(12) Patent Application Publication
(10) Pub. No.: US 2007/0146561 A1
(43) Pub. Date: Jun. 28, 2007

(54) Display apparatus with a display device and a rail-stabilized method of driving the display device

(75) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/580,057

(22) PCT Filed: Nov. 16, 2004
(86) PCT No.: PCT/IB04/52437

§ 371 Date: May 22, 2006

(30) Foreign Application Priority Data
Nov. 25, 2003 (EP) 03104353.2

(51) Int. Cl. G02F 1/13

(52) U.S. Cl. 349/2

(57) ABSTRACT

A cyclic rail-stabilized method of driving an electrophoretic display device (1), wherein a substantially dc-balanced waveform is used to effect various required optical transitions. The driving waveform consists of a sequence of picture potential differences, which cause the charged particles of the electrophoretic display device (1) to move cyclically between extreme optical positions in a single path, irrespective of the image sequence required to be displayed, except in the case where the desired optical transition is from an intermediate position (or grey scale) to the extreme optical position (or rail state) closest to that intermediate position, in which case the optical transition is effected substantially directly by means of a single voltage pulse (20) which is substantially equal in amplitude and duration, but of opposite polarity, to the voltage pulse (30) required to effect an original optical transition from the rail state to that grey scale.

This invention relates to a display apparatus, comprising:
an electrophoretic medium comprising charged particles in a fluid;
a plurality of picture elements;
a first and second electrode associated with each picture element for receiving a potential difference, said charged particles being able to occupy a position being one of a plurality of positions between said electrodes; and
drive means arranged to supply a sequence of picture potential differences to each of said picture elements so as to cause said charged particles to occupy one of said positions for displaying an image.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause it to occupy a position between the electrodes, depending on the value and duration of the applied potential difference, so as to display a picture.

In more detail, an electrophoretic display device is a matrix display with a matrix of pixels which area associated with intersections of crossing data electrodes and select electrodes. A grey level, or level of colourisation of a pixel, depends on the time a drive voltage of a particular level is present across the pixel. Dependent on the polarity of the drive voltage, the optical state of the pixel changes from its present optical state continuously towards one of the two limit situations, e.g. one type of all charged particles is near the top or near the bottom of the pixel. Grey scales are obtained by controlling the time the voltage is present across the pixel.

Usually, all of the pixels are selected line by line by supplying appropriate voltages to the select electrodes. The data is supplied in parallel via the data electrodes to the pixels associated with the selected line. If the display is an active matrix display, the select electrodes with active elements TFT's, MIM's, diodes, which in turn allow data to be supplied to the pixel. The time required to select all the pixels of the matrix display once is called the sub-frame period. A particular pixel either receives a positive drive voltage, a negative drive voltage, or a zero drive voltage during the whole sub-frame period, dependent on the change in optical state required to be effected. A zero drive voltage is usually applied to a pixel if no change in optical state is required to be effected.

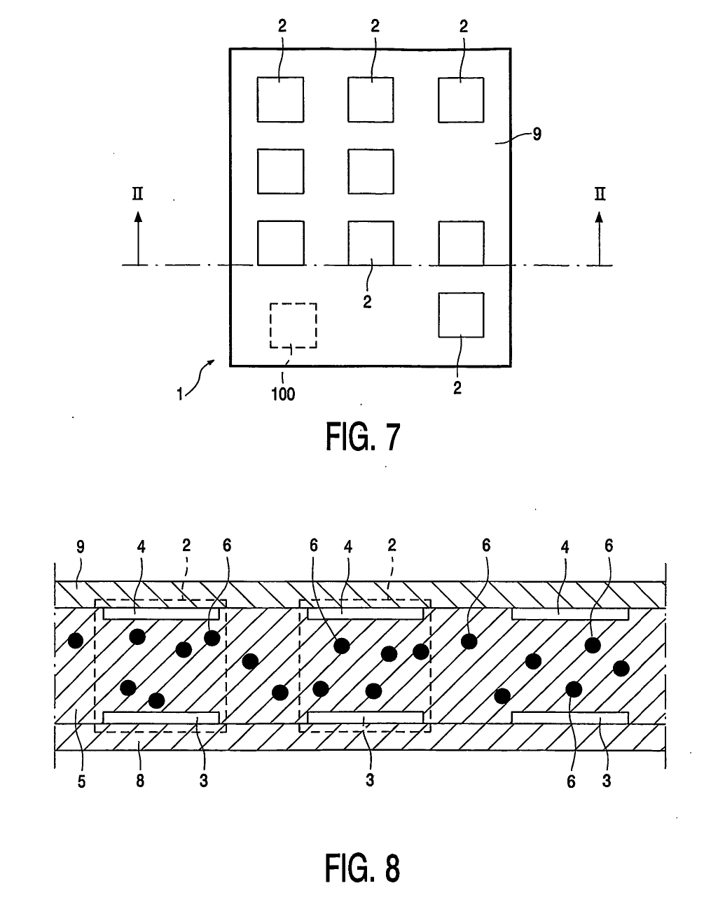

FIGS. 7 and 8 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure. In another embodiment, the picture elements 2 might be arranged in a honeycomb arrangement.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 8, the first substrate 8 has for each picture element 2 a first electrode 3, and the second substrate 9 has for each picture element 2 a second electrode 4. The charged particles 6 are able to occupy extreme positions near the electrodes 3, 4, and intermediate positions between the electrodes 3, 4. Each picture element 2 has an appearance determined by the position of the charged particles 6 between the electrodes 3, 4.

Electrophoretic media are known per se from, for example, U.S. Pat. No. 5,961,804, U.S. Pat. No. 6,120,839 and U.S. Pat. No. 6,130,774, and can be obtained from, for example, E Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

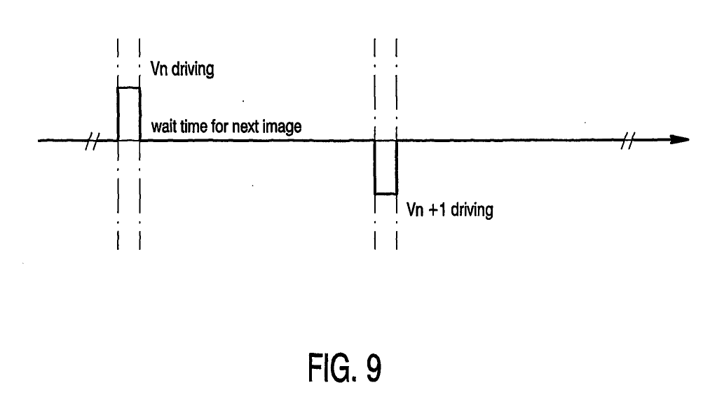

FIG. 9 illustrates part of a typical conventional random greyscale transition sequence using a voltage modulated transition matrix. Between the image state n and the image state n+1, there is always a certain time period (dwell time) available which may be anything from a few seconds to a few minutes, dependent on different users.

In general, in order to generate grey scales (or intermediate colour states), a frame period is defined comprising a plurality of sub-frames, and the grey scales of an image can be reproduced by selecting per pixel during how many sub-frames the pixel should receive which drive voltage (positive, zero, or negative). Usually, the sub-frames are all of the same duration, but they can be selected to vary, if desired. In other words, typically grey scales are generated by using a fixed value drive voltage (positive, negative, or zero) and a variable duration of drive periods.

In a display using electrophoretic foil, many insulating layers are present between the ITO-electrodes, which layers become charged as a result of the potential differences. The charge present at the insulating layers is determined by the charge initially present at the insulating layers and the subsequent history of the potential differences. Therefore, the positions of the particles depend not only on the potential differences being applied, but also on the history of the potential differences. As a result, significant image retention can occur, and the pictures subsequently being displayed according to image data differ significantly from the pictures which represent an exact representation of the image data.

As stated above, grey levels in electrophoretic displays are generally created by applying voltage pulses for specified time periods. They are strongly influenced by image history, dwell time, temperature, humidity, lateral inhomogeneity of the electrophoretic foils, etc. In order to consider the complete history, driving schemes based on the transition matrix have been proposed. In such an arrangement, a matrix look-up table (LUT) is required, in which driving signals for a greyscale transition with different image history are predetermined. However, build up of remnant dc voltages after a pixel is driven from one grey level to another is unavoidable because the choice of the driving voltage level is generally based on the requirement for the grey value. The remnant dc voltages, especially after integration after multiple greyscale transitions, may result in severe image retention and shorten the life of the display.

Thus, it is an object of the present invention, for image transitions from an intermediate grey scale to an extreme position closest thereto, to allow the above-described optical path to be broken, thereby achieving a reduction of image update visibility, image update time, and power consumption.

In accordance with the present invention, there is provided display apparatus comprising:
an electrophoretic medium comprising charged particles in a fluid;
a plurality of picture elements;
a first and second electrode associated with each picture element for receiving a potential difference, said charged particles being able to occupy a position being one of at least four positions, two of said positions being extreme positions substantially adjacent said electrodes and the remaining positions being intermediate positions between said electrodes; and
drive means arranged to supply a sequence of picture potential differences to each of said picture elements so as to cause said charged particles to occupy one of said positions for displaying an image; wherein said sequence of picture potential differences form a driving waveform for a) causing said charged particles to move cyclically between said extreme positions in a single optical path and effect a desired optical transition along said optical path, if the desired optical transition is from a first intermediate position to a second intermediate position or between an intermediate position and the extreme position furthest therefrom, and b) if the desired optical transition is from an intermediate position to the extreme position closest thereto, causing said charged particles to move substantially directly towards the extreme position via the shortest route and effect said optical transition.

Also in accordance with the present invention, there is provided a method of driving a display apparatus comprising:
an electrophoretic medium comprising charged particles in a fluid;
a plurality of picture elements;
a first and second electrode associated with each picture element for receiving a potential difference, said charged particles being able to occupy a position being one of at least four positions, two of said positions being extreme positions substantially adjacent said electrodes and the remaining positions being intermediate positions between said electrodes; and
drive means arranged to supply a sequence of picture potential differences to each of said picture elements so as to cause said charged particles to occupy one of said positions for displaying an image; wherein said sequence of picture potential differences form a driving waveform; the method comprising a) causing said charged particles to move cyclically between said extreme positions in a single optical path and effect a desired optical transition along said optical path, if the desired optical transition is from a first intermediate position to a second intermediate position or between an intermediate position and the extreme position furthest therefrom, and b) if the desired optical transition is from an intermediate position to the extreme position closest thereto, causing said charged particles to move substantially directly towards the extreme position via the shortest route and effect said optical transition.

Still further in accordance with the present invention, there is provided drive means for driving a display apparatus as defined above, the drive means being arranged to supply a sequence of picture potential differences to each of said picture elements so as to cause said charged particles to occupy one of said positions for displaying an image; wherein said sequence of picture potential differences form a driving waveform for a) causing said charged particles to move cyclically between said extreme positions in a single optical path and effect a desired optical transition along said optical path, if the desired optical transition is from a first intermediate position to a second intermediate position or between an intermediate position and the extreme position furthest therefrom, and b) if the desired optical transition is from an intermediate position to the extreme position closest thereto, causing said charged particles to move substantially directly towards the extreme position via the shortest route and effect said optical transition.

Preferably, an optical transition from a first intermediate position and an extreme position closest thereto is effected substantially directly by means of a single voltage pulse, which is preferably of substantially equal amplitude and duration, and of opposite polarity, to the picture potential difference required to effect an optical transition from the extreme position to the intermediate position.

The drive waveform may comprise pulse width modulated voltage pulses, voltage modulated voltage pulses or a combination of the two. The driving waveform is preferably substantially dc-balanced. The drive waveform is preferably preceded by one or more shaking pulses, and if a single shaking pulse is used, this is preferably of a polarity opposite to that of the first pulse of the subsequent drive waveform. The energy value (defined as the integration of voltage pulse with time) of a shaking pulse is preferably sufficient to release the charged particles at one of the extreme positions, but insufficient to move the particles from one of the extreme positions to the other.

These and other aspects of the present invention will be apparent from, and elucidated with reference to, the embodiments described hereinafter.

Embodiments of the present invention will now be described by way of examples only with reference to the accompanying drawings, in which:

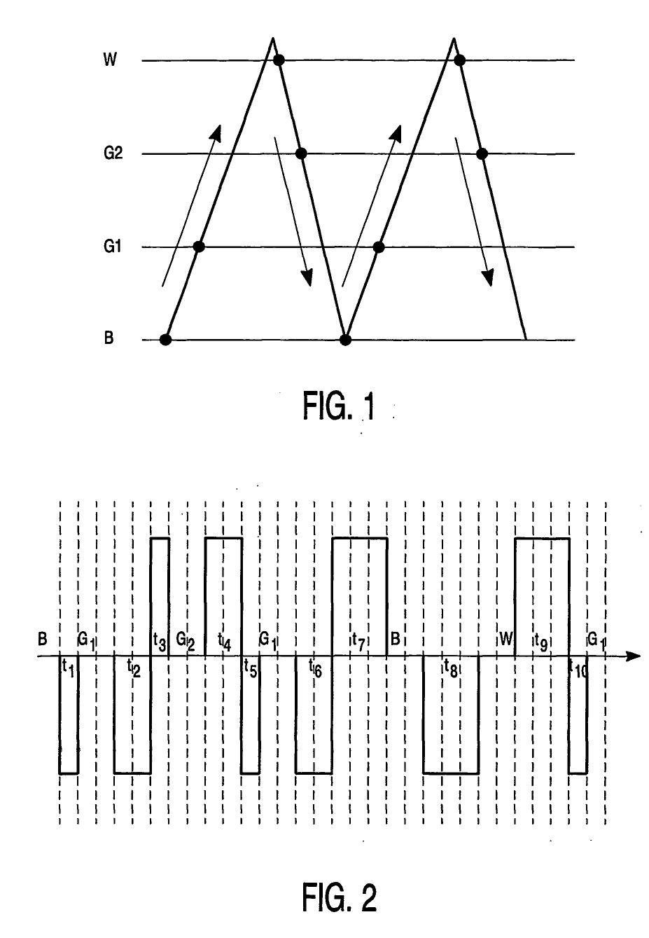

FIG. 1 illustrates schematically a cyclic rail-stabilized driving method for an electrophoretic display having four optical states: white (W), light grey (G2), dark grey (G1) and black (B);

FIG. 2 illustrates a driving waveform for performing optical transitions, in which three items of image history are illustrated for a transition to G1;

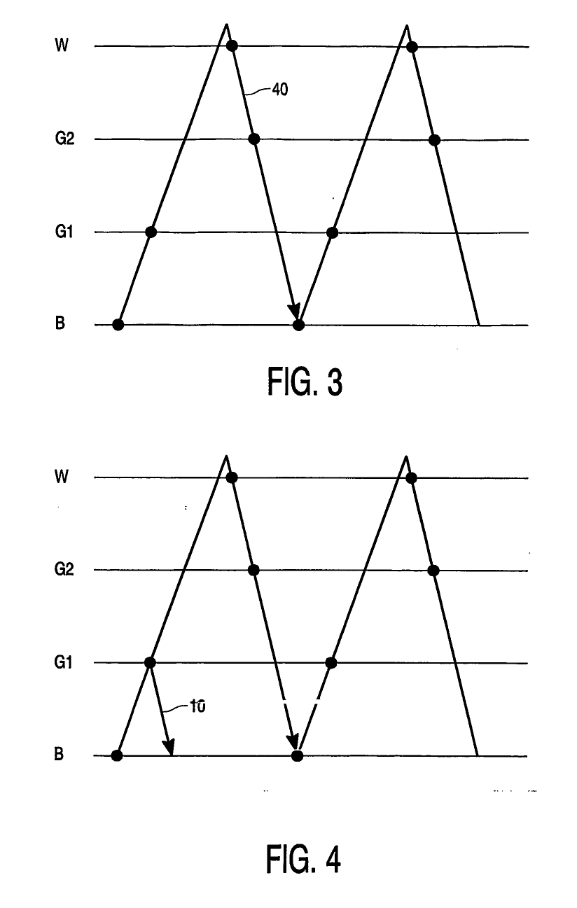

FIG. 3 illustrates schematically a cyclic rail-stabilized driving method for an electrophoretic display, whereby the desired optical transition is from an intermediate position to the extreme position closest to it according to the method illustrated in FIG. 1;

FIG. 4 illustrates schematically a cyclic rail-stabilized driving method for an electrophoretic display having four optical states: white (W), light grey (G2), dark grey (G1) and black (B) according to an exemplary embodiment of the present invention, whereby the desired optical transition is from an intermediate position to the extreme position closest thereto;

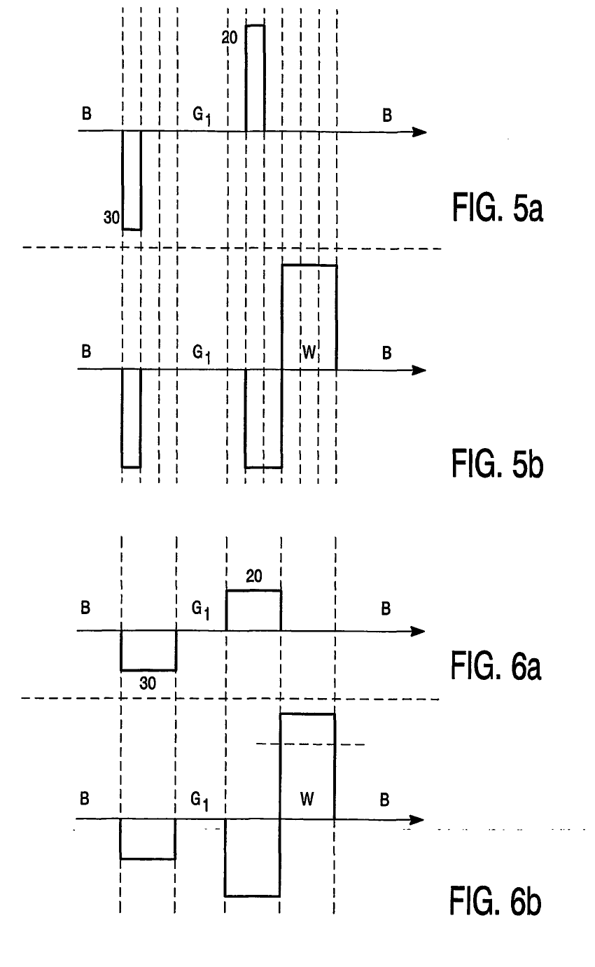

FIG. 5a illustrates a pulse width modulated (PWM) driving waveform for performing the optical transition according to the technique of FIG. 4;

FIG. 5b illustrates a pulse width modulated (PWM) driving waveform for performing the optical transition according to the technique of FIG. 3;

FIG. 6a illustrates a voltage modulated (VM) driving waveform for performing the optical transition according to the technique of FIG. 4;

FIG. 6b illustrates a voltage modulated (VM) driving waveform for performing the optical transition according to the technique of FIG. 3

FIG. 7 is a schematic front view of a display panel according to an exemplary embodiment of the present invention;

FIG. 8 is a schematic cross-sectional view along II-II of FIG. 1; and

FIG. 9 illustrates part of a typical greyscale transition sequence using a voltage modulated transition matrix according to the prior art;

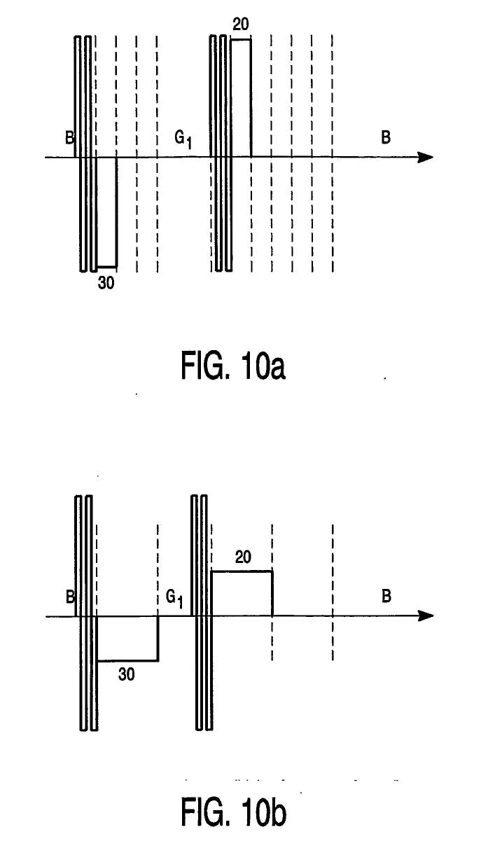

FIG. 10a illustrates an improved driving waveform based on FIG. 5a for performing optical transitions according to an exemplary embodiment of the present invention (based on the technique of FIG. 4): four shaking pulses are applied prior to the drive waveform; and

FIG. 10b illustrates an improved driving waveform based on FIG. 6a for performing optical transitions according to an exemplary embodiment of the present invention (based on the technique of FIG. 4): four shaking pulses are applied prior to the drive waveform.

Thus, as explained above, grey levels in electrophoretic displays are strongly influenced by image history, dwell time, temperature, humidity, lateral inhomogeneity of the electrophoretic foils, etc. It has been demonstrated that accurate grey levels can be achieved using a so-called rail-stabilized approach. This means that the grey levels are always achieved via one of the two extreme optical states (say black or white) or “rails”, irrespective of the image sequence itself.

In order to achieve substantially dc-balanced driving, a cyclic rail-stabilized greyscale concept has recently been proposed, and it is illustrated schematically in FIG. 1 of the drawings. In this method, as stated above, the “ink” must always follow the same optical path between the two extreme optical states, say full black or full white (i.e. the two rails), regardless of the image sequence, as indicated by the arrows in FIG. 1. In the illustrated example, the display has four different states: black (B), dark grey (G1), light grey (G2) and white (W).

The corresponding driving waveform for effecting the illustrative image transitions is illustrated schematically in FIG. 2, and it will be appreciated that, for the sake of simplicity, a pulse width modulated (PWM) driving scheme (i.e. controlling the width of the driving pulses to achieve the desired optical transition) is utilized in this particular example, and a display having ideal ink materials (i.e. insensitive to dwell time and image history) is assumed. However, it will be further appreciated that similar results can be achieved using a voltage modulated (VM) driving scheme (i.e. controlling the height of the driving pulses to achieve the desired optical transition).

Due to the cyclic character of the driving method, the total energy (expressed by time x voltage) involved in a negative pulse, is always equal to that of the subsequent positive pulses.

For example, assume that the current image is in the black state, and the next image to be displayed is dark grey (G1). In this case, a negative voltage pulse with ⅓ of the full pulse width (t₁) is applied (bearing in mind that the “full pulse width” is the pulse width required to change state from full black to full white, or vice versa, so ⅓ of the pulse width, having a negative polarity, is required to move the particles upwards from full black to G1). After a waiting period (dwell time), image G2 needs to be displayed on the pixel. A negative pulse width with ⅔ of the full pulse width (t₂) is used (to reach the full white state), directly followed by a positive pulse with ⅓ of the full pulse width (t₃) to reach G2. Next, the G1 state is required to be displayed after another dwell time. A positive pulse with ⅔ of the full pulse width (t₄) is used, to reach the full black state, directly followed by a negative pulse with ⅓ of the full pulse width (t₅) to reach G1 from there.

Thus, the ink always follows the arrows, such that: t1+t2=t3+t4=t5+t6=t7=t8=t9 . . . In this manner, a DC-balanced driving method is realised, i.e. the remnant DC voltage is zero after the image update.

However, the image update time is excessively long for transitions from a grey level to its closest rail state, because the display is first driven to the opposite rail and then back to the correct grey level. This is illustrated in FIG. 3 for a transition from G1 to B. In addition, the visibility of these transitions is unacceptably great, because the display is first driven to the opposite extreme level and then back to the required state. This also increases power consumption.

Thus, in accordance with the invention, there is proposed an improved driving method for an electrophoretic display having at least two discrete grey levels (intermediate positions). The ink (or charged particles) always follows the same optical path between the two electrodes (or rails), i.e. between the two extreme optical states: full black and full white, regardless of the image sequence for all types of image transition, except for transitions from a grey state to the rail (or extreme optical) state closest thereto. For these transitions, a single voltage pulse is used as the driving pulse, which single pulse has essentially the same duration and amplitude as the driving pulse that was used to achieve that grey level from the rail closest thereto, although its polarity will be opposite. For these special transitions, the above-described optical path is allowed to be broken, and a dc-balanced driving method is achieved with a massive reduction of image update visibility, image update time and power consumption.

An exemplary embodiment of the invention is illustrated schematically in FIG. 4, in which four exemplary states in an electrophoretic display are shown, as in FIG. 1. In the example of a required transition from G1 to black, the short route indicated by the arrow 10 is followed by delivering a single voltage pulse of equal amplitude and duration, but opposite polarity, to the voltage pulse which caused the G1 to be reached previously. By comparison, FIG. 3 illustrates the transition path from G1 to black in accordance with the technique described with reference to FIG. 1.

In one embodiment of the invention, pulse width modulated (PWM) driving waveforms may be used (i.e. constant voltage amplitude and variable pulse duration). The corresponding driving waveform patterns for the transitions illustrated schematically in FIGS. 4 and 3 are illustrated in FIGS. 5a and 5b respectively.

Referring to FIG. 5a of the drawings, it can be seen that a single positive voltage pulse 20 is used as the driving pulse, and has essentially the same duration and amplitude as the driving pulse 30 that was used to achieve the grey level G1, but with an opposite polarity. The remnant DC value is zero after completion of the B to G1 and G1 to B transitions.

For comparison, the resultant waveform of a G1 to B transition using the technique described with reference to FIG. 1 is illustrated schematically in FIG. 5b. In this case, in order to effect a transition from G1 to B, the long route indicated by the arrow 40 in FIG. 3 is followed, and the corresponding driving waveform is illustrated in FIG. 5b. A negative voltage pulse having ⅔ of the full pulse width that is needed for driving the ink from full black to full white, is first supplied and then a positive pulse having a full pulse width is used. The display goes first to the incorrect extreme level (in this case the white state) and then to the required extreme level (in this case the black state). It can be seen that effecting the optical transition in this manner takes a much longer time than in the case of the method illustrated in FIG. 4, as well as having a relatively large image update visibility. The use of the negative pulse followed by a relatively long positive pulse is mainly used for dc balancing, which is not required in the technique of the present invention.

In accordance with another exemplary embodiment of the present invention, voltage modulated (VM waveforms may be used to effect the desired optical transitions (i.e. variable voltage amplitude and constant pulse duration). The corresponding driving pattern to effect the transition G1 to B as illustrated in FIG. 4 is shown in FIG. 6a. A single positive voltage pulse 20 is used as the driving pulse, and has essentially the same duration and amplitude as the driving pulse 30 that was used to achieve the grey level G1, but with an opposite polarity. The remnant DC value is zero after completion of the B to G1 and G1 to B transitions.

For comparison, the resultant waveform of a G1 to B transition using the technique described with reference to FIG. 1 is illustrated schematically in FIG. 6b. In this case, in order to effect a transition from G1 to B, the long route indicated by the arrow 40 in FIG. 3 is followed, and the corresponding driving waveform is illustrated in FIG. 6b. A negative voltage pulse having ⅔ of the full pulse width that is needed for driving the ink from full black to full white, is first supplied and then a positive pulse having a full pulse width is used. The display goes first to the incorrect extreme level (in this case the white state) and then to the required extreme level (in this case the black state). It can be seen that effecting the optical transition in this manner takes a much longer time than in the case of the method illustrated in FIG. 4, as well as having a relatively large image update visibility. The use of the negative pulse followed by a relatively long positive pulse is mainly used for dc balancing, which is not required in the technique of the present invention.

To further improving image quality, reduce image history and dwell time dependence, a shaking pulse is applied prior to the start of the drive waveform according to this invention. In FIGS. 10a and 10b, four shaking pulses are applied prior to the PWM driving waveform and VM drive waveform, respectively. A shaking pulse is a single polarity voltage pulse representing an energy value sufficient to release particles at one of the two extreme positions but insufficient to move the particles from one of the extreme positions to the other extreme position between the two electrodes. When a single shaking pulse is used, its polarity is preferably opposite to the first pulse of the subsequent drive waveform.

In the embodiments described above, precise dc balancing of the driving waveform can theoretically be achieved if it is assumed that the ink used is an ideal ink, i.e. its switching behaviour is not sensitive to dwell time and/or image history. In the case where the ink is dependent on the dwell time and/or image history, because of for example optical requirements, the duration and/or amplitude of the single driving voltage pulse for G1-to-B or G2-to-W transitions may deviate from that of the driving pulse used for achieving the grey level G1 from B or G2 from W. Remnant dc voltages may build up in the display, which can be removed by introducing additional dc-balancing pulses, prior to or post to the drive waveform.

Note that the invention may be implemented in passive matrix as well as active matrix electrophoretic displays. Also, the invention is applicable to both single and multiple window displays, where, for example, a typewriter mode exists. This invention is also applicable to colour bi-stable displays. Also, the electrode structure is not limited. For example, a top/bottom electrode structure, honeycomb structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. Display apparatus (1) comprising:
an electrophoretic medium (5) comprising charged particles (6) in a fluid;
a plurality of picture elements (2);
a first and second electrode (3, 4) associated with each picture element (2) for receiving a potential difference, said charged particles being able to occupy a position being one of at least four positions, two of said positions being extreme positions substantially adjacent said electrodes and the remaining positions being intermediate positions between said electrodes (3, 4); and
drive means arranged to supply a sequence of picture potential differences to each of said picture elements (2) so as to cause said charged particles (6) to occupy one of said positions for displaying an image; wherein said sequence of picture potential differences form a driving waveform for a) causing said charged particles (6) to move cyclically between said extreme positions in a single optical path and effect a desired optical transition along said optical path, if the desired optical transition is from a first intermediate position to a second intermediate position or between an intermediate position and the extreme position furthest therefrom, and b) if the desired optical transition is from an intermediate position to the extreme position closest thereto, causing said charged particles to move substantially directly towards the extreme position via the shortest route and effect said optical transition.

2. Display apparatus (1) according to claim 1, wherein an optical transition from a first intermediate position to an extreme position closest thereto is effected substantially directly by means of a single voltage pulse (20).

3. Display apparatus (1) according to claim 1, wherein said single voltage pulse (20) is of substantially equal amplitude and duration, and of opposite polarity, to the picture potential difference required to effect an optical transition from said extreme position to said intermediate position.

4. Display apparatus (1) according to claim 1, wherein said driving waveform comprises pulse width modulated voltage pulses.

5. Display apparatus (1) according to claim 1, wherein said driving waveform comprises voltage modulated voltage pulses.

6. Display apparatus (1) according to claim 1, wherein the drive waveforms are preceded by single shaking pulse.

7. Display apparatus (1) according to claim 1, wherein the drive waveforms are preceded by more than one shaking pulse

8. Display apparatus (1) according to claim 6 wherein the polarity of the single shaking pulse is opposite to that of the first pulse of the subsequent drive waveform.

9. Display apparatus (1) according to claim 6, wherein the energy value (defined as the integration of voltage pulse with time) of a shaking pulse is sufficient to release the particles (6) at one of the extreme positions but insufficient to move the particles (6) from one of the extreme positions to the other.

10. Display apparatus (1) according to claim 1, wherein said driving waveform is substantially dc-balanced.

11. A method of driving a display apparatus (1) comprising:
an electrophoretic medium (5) comprising charged particles (6) in a fluid;
a plurality of picture elements (2);
a first and second electrode (3, 4) associated with each picture element (2) for receiving a potential difference, said charged particles (6) being able to occupy a position being one of at least four positions, two of said positions being extreme positions substantially adjacent said electrodes (3, 4) and the remaining positions being intermediate positions between said electrodes (3, 4); and
drive means arranged to supply a sequence of picture potential differences to each of said picture elements (2) so as to cause said charged particles (6) to occupy one of said positions for displaying an image, wherein said sequence of picture potential differences form a driving waveform; the method comprising causing said charged particles (6) to move cyclically between said extreme positions in a single optical path and effect a desired optical transition along said optical path, if the desired optical transition is from a first intermediate position to a second intermediate position or between an intermediate position and the extreme position furthest therefrom, and, if the desired optical transition is from an intermediate position to the extreme position closest thereto, causing said charged particles (6) to move substantially directly towards the extreme position via the shortest route and effect said optical transition.

12. Drive means for driving a display apparatus (1) according to claim 1, said drive means being arranged to supply a sequence of picture potential differences to each of said picture elements (2) so as to cause said charged particles (6) to occupy one of said positions for displaying an image; wherein said sequence of picture potential differences form a driving waveform for a) causing said charged particles (6) to move cyclically between said extreme positions in a single optical path and effect a desired optical transition along said optical path, if the desired optical transition is from a first intermediate position to a second intermediate position or between an intermediate position and the extreme position furthest therefrom, and b) if the desired optical transition is from an intermediate position to the extreme position closest thereto, causing said charged particles (6) to move substantially directly towards the extreme position via the shortest route and effect said optical transition.
